(19) United States
(12) Patent Application Publication
(10) Pub. No.: US 2017/0161950 A1
(43) Pub. Date: Jun. 8, 2017

(54) AUGMENTED REALITY SYSTEM AND IMAGE PROCESSING OF OBSCURED OBJECTS

(71) Applicant: GM GLOBAL TECHNOLOGY OPERATIONS LLC, DETROIT, MI (US)

(72) Inventors: THOMAS A. SEDER, WARREN, MI (US); OMER TSIMHONI, WEST BLOOMFIELD, MI (US); EVIATAR TRON, TEL AVIV (IL)

(21) Appl. No.: 14/962,037

(22) Filed: Dec. 8, 2015

(51) Int. Cl. G06T 19/00; G06T 15/30; G02B 5/18; H04N 13/02; G02B 27/01; F21V 8/00; G06T 19/20; G06F 3/01

(52) U.S. Cl. CPC G06T 19/006; G06T 19/20; G06T 15/30; G06F 3/012; G06F 3/013; H04N 13/0203; G02B 27/0101; G02B 27/0179; G02B 27/0172; G02B 6/0035; G02B 5/1828; G02B 2027/0138; G02B 2027/0183; G02B 2027/0118; G02B 2027/0178; G02B 2027/0187

(57) ABSTRACT

A method of displaying augmented reality images for an obscured object relative to a real world scene. An image exterior of a vehicle is captured by an image capture device. A portion of an object occluded by a component of the vehicle as viewed by a person within the vehicle is determined by a processor. An augmented reality image is generated representing the portion of the occluded object over the component of the vehicle. The augmented reality image is displayed on an image plane at a depth that correlates with the real world scene.

### BACKGROUND OF INVENTION

An embodiment relates to an augmented reality system for obscured objects.

Automobiles and other transportation vehicles include an interior passenger compartment in which the driver of the vehicle is disposed and operates vehicle controls therein. The vehicle typically includes transparent glass, such as the front windshield, sidelights, and a rear windshield for allowing the user to view real world scenes exterior of the vehicle. The vehicle typically includes a vehicle frame and body structure that supports the windshields and sidelights. Various pillars (e.g., A-pillars) extend to the roof of the car for supporting the roof. While the pillars are relatively narrow in size in comparison to the front windshield and sidelights, the proximity to the A-pillar to the driver could cause visual blockages in the rear world scene. Objects in the real world scene that may be occluded from the driver's view due to the A-pillar include, but are not limited to, pedestrians, signs, buildings, and other vehicles. Occlusion of such objects may result in accident to the vehicle or an exterior object such as a pedestrian.

### SUMMARY OF INVENTION

An advantage of an embodiment is the display of a real world scene to a driver of the vehicle that would otherwise be occluded by a component of the vehicle inhibiting the drivers view. Moreover, an augmented reality image representing a portion of the real world scene that is occluded is displayed in an image plane over the component of the vehicle and is blended with the real world scene visualized by the driver through the front windshield and sidelights. The augmented reality image is sized and projected at a distance that places the augmented reality image substantially on the same plane as a real world scene. In addition, luminance is controlled so that substantially no distinction is present between the real world scene and the augmented reality image. As a result, the blending of the real world image in the real world scene as seen by the driver is uniform with no obstructions.

An embodiment contemplates a method of displaying augmented reality images for an obscured object relative to a real world scene. An image exterior of a vehicle is captured by an image capture device. A portion of an object occluded by a component of the vehicle as viewed by a driver of the vehicle is determined by a processor. An augmented reality image is generated representing the portion of the occluded object over the component of the vehicle. The augmented reality image is displayed on an image plane at a depth that correlates with the real world scene.

### BRIEF DESCRIPTION OF DRAWINGS

FIG. 1 illustrates a block diagram of the augmented reality display system.

FIG. 2 illustrates a waveguide HUD mounted on a vehicle component.

FIG. 3 is an exemplary graph illustrating the image depth between a real world image and a 2D display image.

FIG. 4 is an exemplary graph illustrating the image depth between a real world image and a 3D display image.

Fig. is a flowchart for applying image processing for generating virtual images of an occluded object.

### DETAILED DESCRIPTION

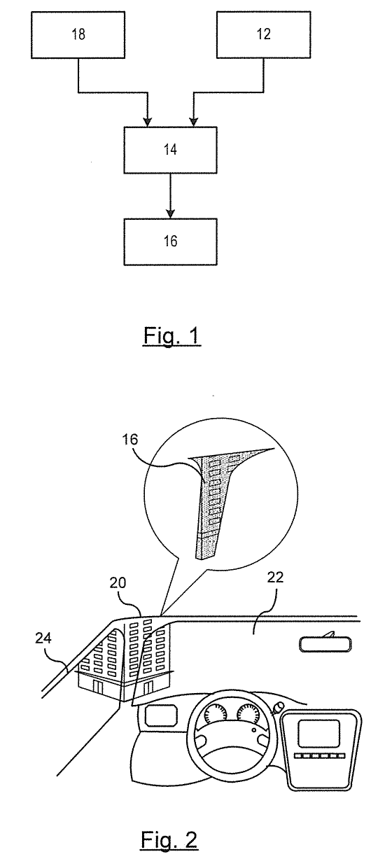

FIG. 1 illustrates a block diagram of the augmented reality display system 10 that includes an image capture device 12, a processor 14, a waveguide head up display (HUD) 16, and a head tracker 18. The system 10 generates an augmented reality display to supplement portions of real world scenes that are occluded by components of the vehicle such as an A-pillar of a vehicle. When a driver is operating the vehicle, the A-pillar can block all or a portion of an object that is aligned between the driver and the object. When an object such as a building, another vehicle, or a pedestrian is aligned with the driver and the A-pillar, such objects may be occluded by the A-pillar. As a result, the augmented reality display system 10 supplements the occluded portion of the object and a holographic display is projected on an image plane beyond the A-pillar so as to supplement portions of the occluded object. It should be understood that term vehicle as used herein is not limited to an automobile and may include, but is not limited to, trains, boats, or planes. Moreover, the HUD and head tracker can further utilized by any passenger within the vehicle.

The image capture device 12 may include a camera or camera system that captured images exterior of the vehicle, and more specifically, images that the driver would be viewing through the front windshield or sidelights (i.e., side window). The image capture device may include, but is not limited to, a three dimensional (3D) camera or a stereo camera. Preferably, the image capture device captures 3D images or is capable of capturing images in 3D or providing images that can be processed into 3D images.

The mounting of the image capture device 12 can be mounted on the vehicle and is in alignment with the driver and A-pillar such that no additional processing is required to align the image. Alternatively, the image capture device 12 may be located at other locations of the vehicle and image processing is performed on the captured image to change the pose of the image capture device 12 for generating an image that is displayed as if the image capture device 12 is mounted on the A-pillar and in alignment with the A-pillar, driver, and occluded object.

A processor 14 may be a standalone processor, a shared processor, or a processor that is part of an imaging system. The processor 14 receives the captured image from the image capture device 12 and performs image processing to the captured image. The processor 14 performs editing functions that includes, but are not limited to image clipping to modify the view as would be seen by a driver if augmented reality glasses are worn, orienting the image based on head orientation of the driver, narrowing the image for sizing the component occluding the exterior object, turning on and off the augmented display based on the driver's eye perspective, adjusting luminance of the display, and blending edges with respect to reality and the augmented display.

The waveguide head up display (HUD) 16 is mounted to the vehicle component that is occluding the object. The waveguide HUD 16 utilizes a holographic diffraction grating that attempts to concentrate the input energy in a respective diffraction order. An example of a diffraction grating may include a Bragg diffraction grating. Bragg diffraction occurs when light radiation with a wavelength comparable to atomic spacings is scattered in a specular pattern by the atoms of a crystalline system, thereby undergoing constructive interference. The grating is tuned to inject light into the waveguide at a critical angle. As light fans out, the light traverses the waveguide. When the scattered waves interfere constructively, the scattered waves remain in phase since the path length of each wave is equal to an integer multiple of the wavelength. The light is extracted by a second holographic diffraction grating that steers the light (e.g., image) into the user's eyes. A switchable Bragg Diffraction Grating may be utilized which includes grooved reflection gratings that give rise to constructive and destructive interference and dispersion from wavelets emanating from each groove edge. Alternatively, multilayer structures have an alternating index of refraction that results in constructive and destructive interference and dispersion of wavelets emanating from index discontinuity features. If one of the two alternating layers is comprised of a liquid crystal material having both dielectric and index of refraction anisotropy, then the liquid crystal orientation can be altered, or switched via an application of an electric field which is known as switchable Bragg Grating.

In an alternative solution, the waveguide HUD 16 may include a head worn HUD such as augmented reality glasses (e.g., spectacles). When utilizing augmented reality glasses that utilize transparent projection displays, the image can by optical design be made to appear at any distance from the wearer's eye. The 3D image is transmitted from the processor 14 to the 3D augmented reality glasses such that the augmented reality image is projected in space thereby filling in an object exterior of the vehicle occluded by the vehicle component.

The head tracker 18 is a device for tracking the head orientation or the eyes. That is, if fewer details are required, then the augmented reality system 10 may utilize a head tracking system which tracks an orientation of the head for determining a direction that the driver is viewing. Alternatively, the augmented reality system 10 may utilize an eye tracking system where the direction (e.g., gaze of the eyes) are tracked for determining whether the occupant is looking in the direction of the vehicle component occluding the object or whether the occupant is looking elsewhere. The head tracker 18 may include a device mounted in the vehicle the monitors either the location of the head or the gaze of the eyes. The head tracker 18 may also be integrated with the waveguide HUD 16 if augmented reality glasses are utilized. In this scenario, an eye tracker would be integrated as part of the spectacles for tracking movements of the eye.

FIG. 2 illustrates the waveguide HUD 16 mounted on a vehicle component such as an A-pillar 20. As shown in FIG. 2, a driver viewing the front windshield 22 sees a 3-D image of a real world scene. The term real world scene as used herein and in the claims is defined as a region exterior of the vehicle as seen by the driver of the vehicle. Similarly, the driver when viewing through the driver's side window 24 sees a 3-D image of an exterior environment outside the vehicle. However, generating a typical two-dimensional (2D) display on the A-pillar 20 would result in a 2D direct view. This would require mental merging of 2D and 3D images. Moreover, a luminance difference would be present between the real world image and the displayed image. FIG. 2 illustrates an enlarged view of the augmented reality image generated by the HUD. The augmented reality image would be sized according to the shape of the A-pillar so that blending of the augmented reality image with the real world scene as seen by the driver through the front windshield and the sidelight is seamless to the driver as no convergence issues are present.

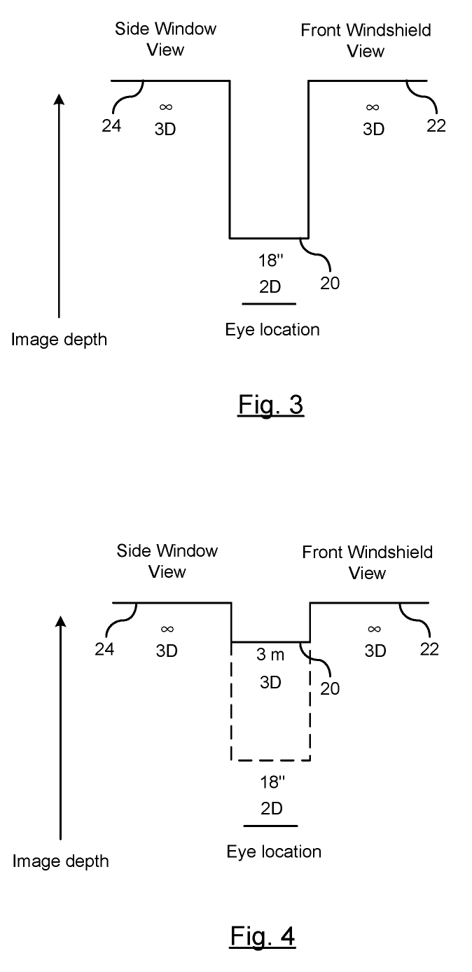

FIG. 3 is a graph illustrating the image depth between a real world scene and a display image. As shown in FIG. 3, both the windshield view 22 and the driver side view 24 represent 3-D images were the object distance learning similar from 5 m to infinity. However, viewing the A-pillar 20 to the driver represents a view of typically 18 inches. As a result, the driver in focusing between the A-pillar 20 and the real world scene requires mental merging of the images at different depths, and therefore, requires mental merging between 3D and 2D images. As a result, projecting a 2D image display on the A-pillar 20 would generate fatigue to the driver due to a re-accommodation of the respective images between 18 inches in infinity. Convergence fatigue at this distance is also an issue.

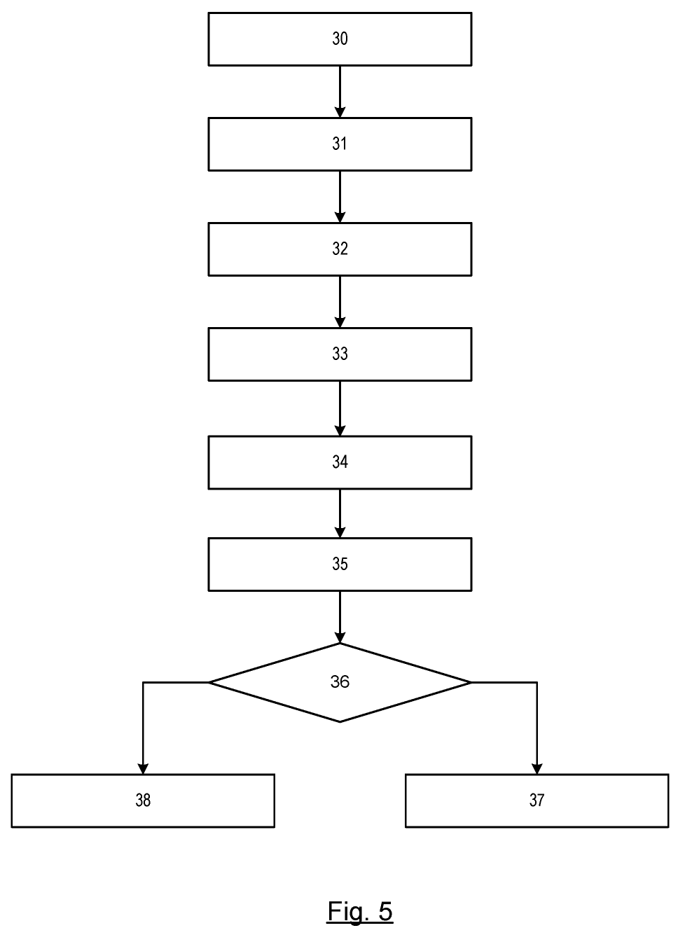

To overcome the issue of fatigue due to the use of displaying images on the A-pillar 20, FIG. 4 illustrates 3D images that are generated over the A-pillar 20. The 3D image is projected out in space on an imaginary image plane via the waveguide HUD 16 thereby eliminating disorientation due to the combining 2D and 3D images. The graph as illustrated in FIG. 4 shows the image depth between a real world image and a projected virtual image. As shown in FIG. 4, both the windshield view 22 and the sidelight view 24 represent 3D real world images where the image plane is located at a distance 5 meters to infinity. It should be understood that there is no substantial distinction in a perception in the focal length of a person viewing an object once the object distance is between 3 meters and infinity. As a result, the driver can readily merge scenes between the real world image and the augmented reality display generated over the A-pillar 20 since a change in convergence of objects from three meters to infinity is relatively small.

FIG. 5 represents a flowchart of applying image processing for generating augmented reality images of the object on the vehicle component occluding the object. In block 30, images are captured by the image capture device. The image may be 3D images, 2D, or a set of stereo cameras may capture the image for generating a 3D image.

In block 31, if augmented reality glasses are utilized, then the image is clipped to accommodate the field of view of the augmented reality glasses.

In step 32, image perspective and stabilization is applied. Devices including, but not limited to, a gyroscope and accelerometers may be used to determine an orientation of the driver's head. The gyroscope and accelerometers maintain stable and aligned images as the head is rotated. In addition, an eye tracker or head tracker may be used to determine a distance from the A-pillar to the driver's eye and the direction the driver is looking. Examples of tracking systems may include a head tracker, which monitors movements of the head in the direction that the head is facing. More complex devices and systems would include a gaze tracker which tracks movements of the eyes for determining the direction that the eyes are looking. A gaze tracker provides more details such that the driver may not necessarily move his head, but may rotate his eyes without movement of the head to look away from the road of travel. As a result, a gaze tracker would provide more detailed information as to when the driver may be looking in a direction of the A-pillar.

In step 33, view port narrowing is applied. A size, determined by the dimensions of A-pillar, and distance to the A-pillar is determined for sizing the image accordingly. If glasses are used, a view port of the glasses is narrowed to project the augmented reality image of the occluded portion of the object onto the A-pillar. Similarly, if the waveguide HUD is disposed on A-pillar, then the portion of the occluded object is narrowed to accommodate the size of the A-pillar. Image processing will be applied to the image such that only the portion of the occlusion is displayed on the A-pillar and the image displayed is trimmed in size so that the depth of the virtual image blends with the real world image seen through the front windshield and side window.

In step 34, a luminance of the augmented reality image is adjusted. The luminance is adjusted to a predetermined percentage (e.g., 90%) of the external real-world to avoid cognitive capture (e.g., a user will attend to the displayed image and ignore the real world image if the displayed image is too salient as is the case for an image with an overly high luminance. A luminance sensor may be used to control 3D image luminance.

In step 35, edge blending filtering is applied to blend the luminance of the edges of the virtual image at the pillar's edges to the real world scene. The luminance is reduced by a predetermined percentage (e.g., 50%) at the pillar's edge by applying Gaussian to minimize stark and distracting luminance discontinuity at the edges.

In step 36, a determination is made whether the driver is looking at the A-pillar for a duration of time greater than 500 ms. If the determination is made that the driver is looking at the A-pillar for duration of time greater than 500 ms, then the virtual image is presented to the driver over the A-pillar. If the determination is made that the driver is not looking at an A-pillar for at least a predetermined period of time, then the virtual image is not presented to the driver. An advantage of not having to present the image to the driver reduces processing time by the processor and energy consumption. In response to the driver not looking at the A-pillar for at least a predetermined period of time or the driver looking away from A-pillar, a return is made to step 30 to acquire new images and monitor the driver's viewing of the A-pillar as set forth in steps 30-36.

It should be understood that while advantages herein describe utilizing the 3D HUD, the HUD can be designed to produce either 2D or 3D images. Both 2D and 3D images can work in the embodiments described herein, but the advantage is that 3D images are produced by presenting different images to each eye whereas 2D images are generated by presenting the same image to both eyes.

While certain embodiments of the present invention have been described in detail, those familiar with the art to which this invention relates will recognize various alternative designs and embodiments for practicing the invention as defined by the following claims.

1. A method of displaying augmented reality images for an obscured object relative to a real world scene, the method comprising the steps of:
determining a gaze of an occupant of a vehicle;
determining whether the gaze of the occupant is directed at a component of the vehicle for greater than a predetermined period of time;
capturing an image exterior of the vehicle by an image capture device;
determining, by a processor, a portion of an object occluded by the component of the vehicle as viewed by the occupant of the vehicle;
generating an augmented reality image representing the portion of the occluded object over the component of the vehicle, in response to the gaze of the occupant being directed at the component for greater than the predetermined period of time, wherein the augmented reality image is displayed on an image plane at a depth that correlates with the real world scene.

2. The method of claim 1 wherein the augmented reality image displayed over the component blends with the real world scene.

3. The method of claim 2 further comprising the step of adjusting a luminance of the augmented reality image using a luminance sensor to blend the augmented reality image with the real world scene.

4. The method of claim 2 further comprising the step of applying edge blend filtering by adjusting a luminance of the augmented reality image edges of the component to blend the augmented reality image with the real world scene.

5. The method of claim 1 wherein the augmented reality image is generated by spectacles, wherein the augmented reality image generated by the spectacles over the component.

6. The method of claim 5 wherein further comprising the step of clipping the augmented reality image to accommodate a field-of-view of the spectacles.

7. The method of claim 5 wherein an image plane used to display the augmented reality image by the spectacles is set to any distance by optical design of the spectacles.

8. The method of claim 1 wherein a waveguide heads up display (HUD) is mounted on the component to generate the augmented reality image over the component.

9. The method of claim 8 wherein the waveguide HUD applies a Bragg diffraction grating to generate the augmented reality image over the component.

10. The method of claim 8 wherein the waveguide HUD applies a switchable Bragg diffraction grating to generate the augmented reality image over the component.

11. The method of claim 1 further comprising the step of applying head tracking to determine an orientation of the occupant's head.

12. The method of claim 1 further comprising the step of applying eye tracking for determining a viewing perspective of the occupant.

13. The method of claim 12 wherein eye tracking is applied to determine a distance from an occupant's eye to the component.

14. (canceled)

15. (canceled)

16. The method of claim 1 further comprising the step of inhibiting the reality augmented image from being displayed in response to the gaze of the occupant being directed at the component for less than the predetermined period of time.

17. The method of claim 1 wherein the augmented reality image is generated on an image display plane that is at least at 3 meters from the occupant.

18. The method of claim 1 wherein the augmented reality image is generated on an image display plane that is at least at 5 meters from the occupant.

19. The method of claim 1 wherein the augmented reality image is generated as a 2-dimensional image.

20. The method of claim 1 wherein the augmented reality image is generated as a 3-dimensional image.

21. (canceled)
